(19) United States
(12) Patent Application Publication
(10) Pub. No.: US 2005/0000702 A1
(43) Pub. Date: Jan. 6, 2005

(54) Fire extinguisher

(76) Inventor: Young-Bo Shim, Seoul (KR)

Correspondence Address: Peter T. Kwon;G W I P S, Kangnam P.O. Box 2301, Seoul, 135-242, KR

(21) Appl. No.: 10/746,517

(22) Filed: Dec. 26, 2003

(30) Foreign Application Priority Data
Jun. 19, 2003 (KR) 2003-0019325

(51) Int. Cl. A62C 11/00

(52) U.S. Cl. 169/51; 169/30; 222/530; 222/538

(57) ABSTRACT

An improved fire extinguisher comprises a cylindrical shell, a head element attached to the top end of the cylindrical shell and having a path formed therein, and a discharge hose coupled to the head element to communicate with the head element, wherein the discharge hose is fixed to the cylindrical shell by means of a magnet formed on the discharge hose or the cylindrical shell. Therefore, the discharge hose can be fixed to the cylindrical shell and is separated from the cylindrical shell rapidly and easily.

### BACKGROUND OF THE INVENTION

1. Field of the Invention

The present invention relates to a fire extinguisher, and more specifically, to a fire extinguisher having a discharge hose that provides a discharge path of a fire-suppressing agent contained in a cylindrical shell.

2. Discussion of Related Prior Art

A fire extinguisher is equipped in a variety of places such as buildings, vehicles and ships and has been widely used to extinguish a fire at an early stage. If a fire occurs, a discharge hose in this fire extinguisher is aimed at an ignition source and a fire-suppressing agent contained in a cylindrical shell is discharged through a discharge hose.

FIG. 3 is a perspective view illustrating the configuration of a fire extinguisher according to a prior art.

Referring to FIG. 3, the conventional fire extinguisher includes a cylindrical shell 110, a head element 120 of an approximate T shape attached to the top end of the cylindrical shell 110, a discharge hose 130 and an opening/closing manipulation unit 140 coupled to the head element 120, a discharge tube (not shown) disposed within the cylindrical shell 110 along its longitudinal direction, and an opening/closing rod (not shown) for opening/closing a path between the discharge tube (not shown) and the discharge hose 130.

The head element 120 has a protruded shell coupler 122 its bottom and a protruded hose coupler 125 at its lateral side. Therefore, the shell coupler 122 connects the cylindrical shell 110 to the head element 120 and the hose coupler 125 connects the discharge hose 130 to the head element 120.

The opening/closing manipulation unit 140 includes an actuating lever 141 fixed to the top end of the head element 120, a handle 142 pivotally attached to the actuating lever 141, and a compression spring (not shown) received within the shell coupler 122.

Furthermore, the conventional fire extinguisher has a hose strap 151 provided around the fire extinguisher, for holding the free end of the discharge hose 130 against the cylindrical shell 110 for not in use. A circular arc ring 151a is formed at the hose strap 151.

Hereinafter, how to use the fire extinguisher constructed above will be described in detail.

In normal times, the fire extinguisher is kept in the custody with the discharge hose 30 inserted into the ring 151a of the hose strap 151. If a fire occurs, a user uses one hand to separate the discharge hose 130 from the hose strap 151 by pulling the hose and then to aim the discharge hose 130 at an ignition source.

Next, if the user uses the other hand to press the handle 142 toward the actuating lever 141, the opening/closing rod (not shown) descends and a path between the discharge hose 130 and the discharge tube (not shown) is thus opened. If the path between the discharge hose 130 and the discharge tube (not shown) is opened, the fire-suppressing agent contained in the cylindrical shell 110 is discharged toward the outside through the discharge tube (not shown) and the discharge hose 130. Meanwhile, while the opening/closing rod (not shown) is descending, an elastic force is accumulated on the compression spring (not shown).

If the pressure applied to the handle 142 is released after the fire is completely extinguished, the opening/closing rod (not shown) returns to its original position due to the elastic force accumulated on the compression spring (not shown) and the path between the discharge hose 130 and the discharge tube (not shown) is closed. Accordingly, the discharge of the fire-suppressing agent through the discharge hose 130 is stopped.

In the conventional fire extinguisher, however, when the discharge hose 130 is fixed to the discharge shell 110, the discharge hose 130 has to be pressed enough to insert the hose 130 into the ring 151 a of the hose strap 151. When the discharge hose 130 is separated from the shell 110, the discharge hose 130 must be pulled enough to separate the hose 130 from the ring 151a of the hose strap 151. For this reason, there is a problem in that some time is taken to fix and separate the discharge hose 130 to and from the shell 110.

In particular, the suppression of a fire requires prompt treatment. If some time is wasted in separating the discharge hose 130 from the shell 110, a time to extinguish the fire is lost is missed. In this case, there are problems in that lots of economic loss may be caused or life may be sacrificed.

### SUMMARY OF THE INVENTION

Accordingly, the present invention has been made in view of the above problems, and it is an object of the present invention to provide a fire extinguisher wherein a discharge hose is rapidly and easily fixed to and separated from a cylindrical shell.

To achieve the above objects, according to the present invention, there is provided a fire extinguisher, including a cylindrical shell, a head element attached to the top end of the cylindrical shell and having a path formed therein, and a discharge hose coupled to the head element to communicate with the head element, wherein the discharge hose is fixed to the cylindrical shell by means of a magnet formed on the discharge hose or the cylindrical shell.

In the above, the fire extinguisher further comprises a hose trap formed around the discharge hose, and the cylindrical shell is made from a magnetic material and the magnet is formed on the hose strap.

Furthermore, the fire extinguisher further comprises a shell strap formed around the cylindrical shell, and an absorbing member of a magnetic material formed in an opposite region of the magnet of the discharge hose, and the magnet is formed on the shell strap to opposite to the discharge hose.

In addition, the fire extinguisher further comprises a shell strap formed around the cylindrical shell, and the magnet is formed on the shell strap to opposite to the discharge hose, and the discharge hose has an absorbing region of a magnetic material opposite to the magnet.

### BRIEF DESCRIPTION OF THE DRAWINGS

FIG. 1 is a perspective view illustrating the configuration of a fire extinguisher according to an embodiment of the present invention.

FIG. 2 is a perspective view illustrating the configuration of a fire extinguisher according to another embodiment of the present invention.

FIG. 3 is a perspective view illustrating the configuration of a fire extinguisher according to a prior art.

### DETAILED DESCRIPTION OF PREFERRED EMBODIMENTS

Now the preferred embodiments according to the present invention will be described with reference to the accompanying drawings.

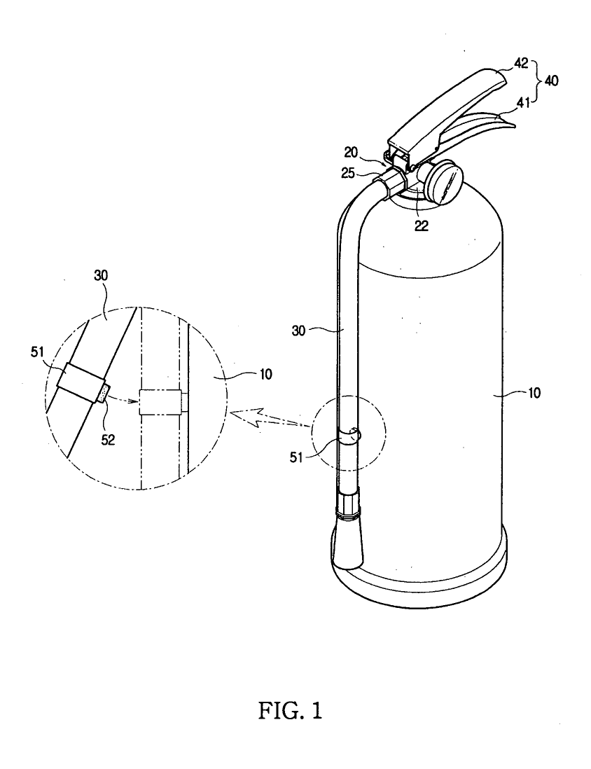

FIG. 1 is a perspective view illustrating the configuration of a fire extinguisher according to an embodiment of the present invention.

Referring to FIG. 1, the fire extinguisher according to the present invention includes a cylindrical shell 10, a head element 20 of an approximate T shape attached to the top end of the cylindrical shell 10, a discharge hose 30 and an opening/closing manipulation unit 40 coupled to the head element 20, a discharge tube (not shown) disposed within the cylindrical shell 10 along its longitudinal direction, and an opening/closing rod (not shown) disposed between the discharge tube (not shown) and the discharge hose 30.

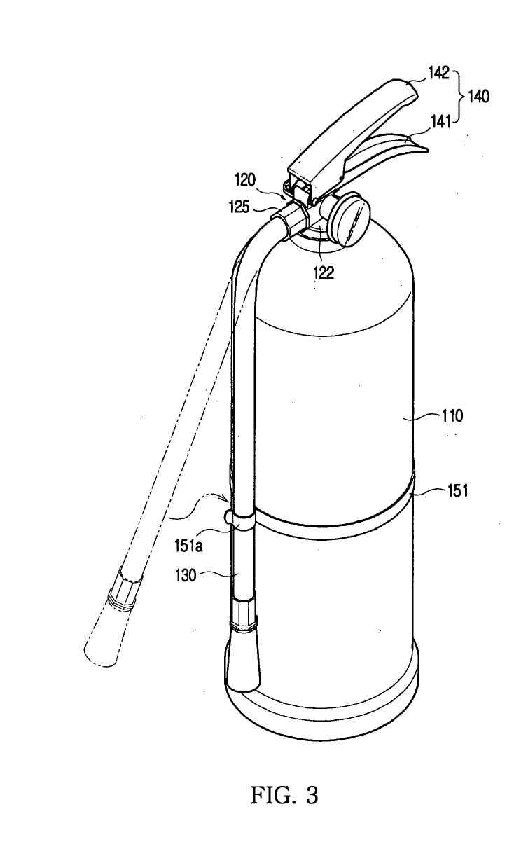

The constructions and functions of the head element 20, the opening/closing manipulation unit 40, the discharge tube (not shown) and the opening/closing rod (not shown) are same as those in the prior art described with reference to FIG. 3. Therefore, detailed description on them will be omitted, for clarity of explanation.

In the above, the cylindrical shell 10 is made from a magnetic material. The discharge hose 30 has a hose strap 51 at its lower side, and a magnet 52 formed on the hose strap 51. The discharge hose 30 constructed above is attached to the cylindrical shell 10 due to a magnetic force occurring from the magnet 52.

Hereinafter, how to use the fire extinguisher constructed above will be described in detail.

In normal times, the fire extinguisher is kept in the custody. If a fire occurs, a user uses one hand to pull the discharge hose 30 from the cylindrical shell 10 and then to aim the hose 30 at the ignition source.

As in the prior art, the user then uses the other hand to press the handle 42 toward the actuating lever 41 so that a fire-suppressing agent contained in the cylindrical shell 10 is discharged toward the ignition source through the discharge hose 30. After the fire is extinguished, the user releases the pressure applied to the handle 42, whereby the discharge of the fire-suppressing agent through the discharge hose 30 is stopped.

Finally, if the user releases the discharge hose 30, the discharge hose 30 approaches the cylindrical shell 10 due to its self-weight and is then attached to the cylindrical shell 10 due to the magnetic force of the magnet 52.

As described above, the cylindrical shell 10 is made from the magnetic material, the hose strap 51 is formed around the discharge hose 30 and the magnet 52 is formed on the hose strap 51. With this structure, the discharge hose 30 can be fixed to the cylindrical shell 10 by just releasing the discharge hose 30, or separated from the cylindrical shell 10 by pulling the discharge hose 30 with a minimum force.

Furthermore, the hose strap 51 not having a ring is used as a member for fixing the discharge hose 30. It thus causes the member for the discharge hose to be easily manufactured, compared to the prior art.

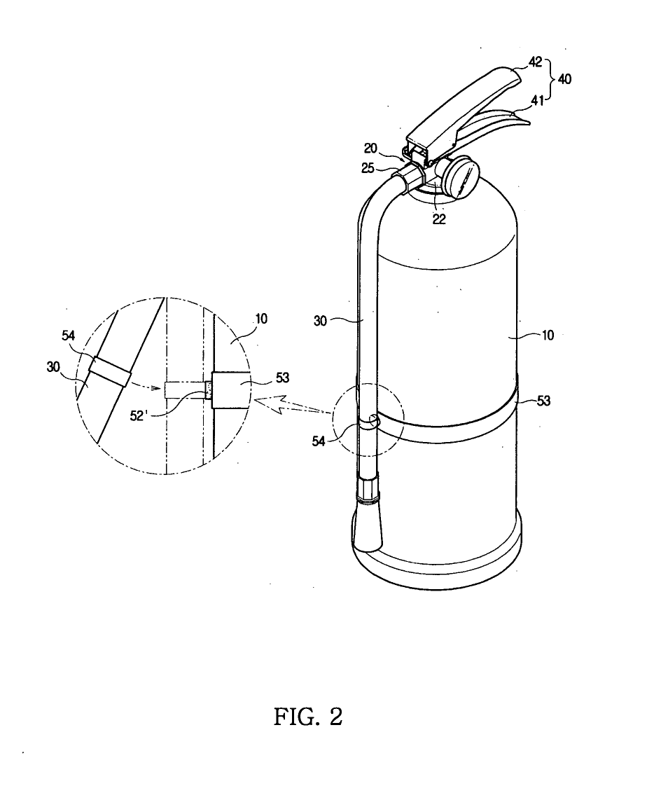

Meanwhile, it has been described in the aforementioned embodiment that the hose strap 51 is formed around the discharge hose 30. It is however to be noted that a shell strap 53 may be formed around the cylindrical shell 10, as shown in FIG. 2. For simplicity of explanation, the same reference numerals in FIG. 2 are used to identify components having the same structure and function as those described with reference to FIG. 1.

Referring to FIG. 2, a fire extinguisher according to another embodiment of the present invention includes the shell strap 53 formed around the cylindrical shell 10, and a magnet 52′ formed on the shell strap 53 to be opposite to the discharge hose 30. Furthermore, an absorbing member 54 is made of a magnetic material and is formed on the discharge hose 30 to be opposite to the magnet 52′.

In the fire extinguisher according to another embodiment of the present invention, the absorbing member 54 is formed on the discharge hose 30. It is however to be understood that the discharge hose 30 may be constructed to have an absorbing region of a magnetic material opposite to a magnet, instead of forming the absorbing member 54 thereon.

In the fire extinguisher according to another embodiment and still another embodiment of the present invention, the discharge hose 30 may be fixed to the cylindrical shell 10 or separated from the cylindrical shell 10 with the same method described above.

As described above, the present invention has a new effect that a discharge hose can be fixed to a cylindrical shell or separated from the cylindrical shell, rapidly and easily, by means of a magnetic force of a magnet.

Although the foregoing description has been made with reference to the preferred embodiments, it is to be understood that changes and modifications of the present invention may be made by the ordinary skilled in the art without departing from the spirit and scope of the present invention and appended claims.

1. A fire extinguisher, the extinguisher including a cylindrical shell, a head element attached to the top end of the cylindrical shell and having a path formed therein, and a discharge hose coupled to the head element to communicate with the head element, being characterized in that:
the discharge hose is fixed to the cylindrical shell by means of a magnet formed on the discharge hose or the cylindrical shell.

2. The fire extinguisher as claimed in claim 1, further comprising a hose trap formed around the discharge hose, and
wherein the cylindrical shell is made from a magnetic material and the magnet is formed on the hose strap.

3. The fire extinguisher as claimed in claim 1, further comprising a shell strap formed around the cylindrical shell, and an absorbing member of a magnetic material formed in an opposite region of the magnet of the discharge hose, and
wherein the magnet is formed on the shell strap to opposite to the discharge hose.

4. The fire extinguisher as claimed in claim 1, further comprising a shell strap formed around the cylindrical shell, and
wherein the magnet is formed on the shell strap to opposite to the discharge hose, and the discharge hose has an absorbing region of a magnetic material opposite to the magnet.
